(19) United States
(12) Patent Application Publication
(10) Pub. No.: US 2025/0158518 A1
(43) Pub. Date: May 15, 2025

(54) BIDIRECTIONAL RESONANT CONVERTER

(71) Applicant: Delta Electronics (Shanghai) Co., Ltd., Shanghai (CN)

(72) Inventors: Feidong Xu, Shanghai (CN); Bin Wang, Shanghai (CN); Xiaoping Wang, Shanghai (CN); Weiyi Zheng, Shanghai (CN)

(21) Appl. No.: 18/945,387

(22) Filed: Nov. 12, 2024

(30) Foreign Application Priority Data
Nov. 14, 2023 (CN) 202311517972.3

(51) Int. Cl. H02M 3/00; H02M 3/335

(52) U.S. Cl. CPC H02M 3/01; H02M 3/33573; H02M 3/33584

(57) ABSTRACT

A bidirectional resonant converter includes a first port, a second port, a first circuit, a resonant circuit, a transformer, a second circuit and a selection unit. The transformer includes a plurality of primary windings. The resonant circuit comprise a plurality of resonant branches. Each resonant branch is electrically connected with at least one primary winding. The plurality of resonant branches and the corresponding primary windings are collaboratively formed as a plurality of connection paths. The selection unit is electrically connected with the plurality of connection paths, and selects at least one connection path from the plurality of connection paths. A resonant cavity between the first circuit and the transformer is formed. The resonant cavity is selected according to the working mode, and the parameters of the resonant cavity are correspondingly changed.

### CROSS-REFERENCE TO RELATED APPLICATION

This application claims priority to China Patent Application No. 202311517972.3 filed on Nov. 14, 2023, the entire content of which is incorporated herein by reference for all purposes.

### FIELD OF THE INVENTION

The present disclosure relates to a resonant converter, and more particularly to a bidirectional resonant converter.

### BACKGROUND OF THE INVENTION

With the continuous technology development and the market drive of policies for smart microgrids, energy storage systems, and electric vehicle systems, high-power dual-active bridge (DAB) converters have received widespread attention and application. Due to the rapid development of new power devices, high-frequency digital processing chips and high-frequency magnetic devices, the importance of high-power DAB converters is further highlighted. Generally, the high-power DAB converter has the advantages of electrical isolation, soft switching operation, high power density, high efficiency, bidirectional energy flow and high reliability.

However, the existing high-power DAB converter still has some drawbacks. For example, when the high-power DAB converter is operated in a wide voltage range, the voltage gain is far away from 1. Since the primary-secondary phase shift angle is too large, the reactive power increases and the equipment efficiency is low.

Therefore, it is important to provide an improved bidirectional resonant converter in order to overcome the drawbacks of the conventional technologies.

### SUMMARY OF THE INVENTION

An object of the present disclosure provides a bidirectional resonant converter. Each resonant branch is electrically connected with at least one primary winding of the transformer. The resonant branches and the corresponding primary windings are collaboratively formed as a plurality of connection paths. The selection unit is electrically connected with a plurality of connection paths. Through the selection unit, at least one connection path of the plurality of connection paths is selected. Consequently, a resonant cavity between the first switching circuit and the transformer is formed. According to the technology of the present disclosure, the parameters of the resonant cavity are correspondingly changed. The corresponding resonant cavity is selected according to the working mode. Since the bidirectional resonant converter is operated in a wide voltage range, the high-efficiency conversion of the electrical energy can be achieved.

In accordance with one aspect of the present disclosure, the bidirectional resonant converter includes a first port, a second port, a first circuit, a resonant circuit, a transformer, a second circuit and a selection unit. The first circuit is electrically connected with the first port. The resonant circuit is electrically connected with the first circuit. The resonant circuit includes a plurality of resonant branches. The primary side of the transformer is electrically connected with the resonant circuit. The primary side of the transformer includes a plurality of primary windings. The second circuit is electrically connected between the secondary side of the transformer and the second port. Each resonant branch is electrically connected with at least one primary winding. The plurality of resonant branches and the corresponding primary windings are collaboratively formed as a plurality of connection paths. The selection unit is electrically connected with the plurality of connection paths, and at least one connection path of the plurality of connection paths is selected through the selection unit. Consequently, a resonant cavity between the first circuit and the transformer is formed.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a circuitry topology of a bidirectional resonant converter according to a first embodiment of the present disclosure;

FIG. 2A is a schematic circuit diagram illustrating the operation of the bidirectional resonant converter of FIG. 1 and operated in a discharging mode for converting voltage;

FIG. 2B is a schematic circuit diagram illustrating the operation of the bidirectional resonant converter of FIG. 1 and operated in a charging mode for converting voltage;

FIG. 3 is a schematic circuit diagram illustrating a circuitry topology of a bidirectional resonant converter according to a second embodiment of the present disclosure;

FIG. 4A is a schematic circuit diagram illustrating the operation of the bidirectional resonant converter of FIG. 3 and operated in a discharging mode for converting voltage;

FIG. 4B is a schematic circuit diagram illustrating the operation of the bidirectional resonant converter of FIG. 3 and operated in a charging mode for converting voltage;

FIG. 5 is a schematic circuit diagram illustrating a circuitry topology of a bidirectional resonant converter according to a third embodiment of the present disclosure;

FIG. 6A is a schematic circuit diagram illustrating the operation of the bidirectional resonant converter of FIG. 5 and operated in a discharging mode for converting voltage;

FIG. 6B is a schematic circuit diagram illustrating the operation of the bidirectional resonant converter of FIG. 5 and operated in a charging mode for converting voltage; and

FIG. 7 is a flowchart illustrating a control method for the bidirectional resonant converter shown in FIG. 1.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

The present disclosure provides a bidirectional resonant converter. Preferably but not exclusively, the bidirectional resonant converter is a bidirectional isolation resonant converter. The bidirectional resonant converter includes a first port, a first circuit, a resonant circuit, a transformer, a second circuit and a second port. The first circuit is electrically connected with the first port. The resonant circuit is electrically connected between the first circuit and the transformer. The transformer includes a primary side and a secondary side. The primary side of the transformer is electrically connected with the resonant circuit. The secondary side of the transformer is electrically connected with the second circuit. The second circuit is electrically connected between the secondary side of the transformer and the second port. The primary side of the transformer includes a plurality of windings. The resonant circuit includes a plurality of resonant branches. Each resonant branch is electrically connected with at least one primary winding. The resonant branches and the corresponding primary windings are collaboratively formed as a plurality of connection paths. The resonant branch in each connection path includes a first resonant capacitor and a first resonant inductor. Consequently, each connection path has at least one resonant frequency. In addition, the at least one primary winding in each connection path and the secondary winding has at least one turn ratio.

The bidirectional resonant converter further includes a selection unit. The selection unit is electrically connected with a plurality of connection paths. Through the selection unit, at least one connection path of the plurality of connection paths is selected. Consequently, a resonant cavity between the first circuit and the transformer is formed, and a turn ratio of the turn number of the corresponding primary winding of the transformer to the turn number of the secondary winding is determined. The selection unit includes a plurality of switches or relays. Each switch or relay is electrically connected with the corresponding connection path.

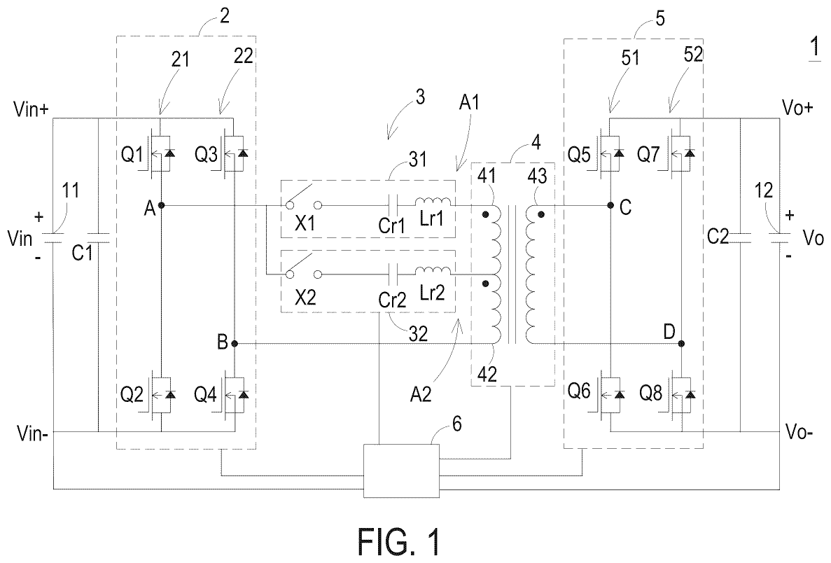

The bidirectional resonant converter further includes a controller. The working mode of the resonant converter can be determined by the controller. According to the working mode of the resonant converter, the controller controls the states of the switches or relays. If the controller determines that the resonant converter is operated in the discharging mode or converts a low voltage into a high voltage, a portion of the switches or relays are in the turn-on state and another portion of the switches or relays are in the turn-off state under control of the controller. Consequently, at least one connection path is selected. A first resonant cavity is defined by the selected at least one connection path for converting voltage. Consequently, the electrical energy flows between the first port and the second port. The first resonant cavity has a first resonant frequency. The first resonant frequency is obtained according to the resonant branch in the selected at least one connection path. The transformer has a first turn ratio. The first turn ratio is determined according to the turn number of the primary winding corresponding to the selected at least one connection path and the turn number of the secondary winding. If the controller determines that the resonant converter is operated in the charging mode or converts the high voltage into the low voltage, a portion of the switches or relays are in the turn-on state and another portion of the switches or relays are in the turn-off state under control of the controller. Consequently, at least one connection path is selected. A second resonant cavity is defined by the selected at least one connection path for converting voltage. Consequently, the electrical energy flows between the first port and the second port. The second resonant cavity has a second resonant frequency. The second resonant frequency is obtained according to the resonant branch in the selected at least one connection path. The transformer has a second turn ratio. The second turn ratio is determined according to the turn number of the primary winding corresponding to the selected at least one connection path and the turn number of the secondary winding. FIG. 1 is a schematic circuit diagram illustrating a circuitry topology of a bidirectional resonant converter according to a first embodiment of the present disclosure. Preferably but not exclusively, the bidirectional resonant converter is a dual active bridge series resonant converter. As shown in FIG. 1, the bidirectional resonant converter 1 includes a first port 11, a second port 12, a first capacitor C1, a first switching circuit 2, a resonant circuit 3, a transformer 4, a second switching circuit 5, a second capacitor C2 and a controller 6. The first capacitor C1 and the first switching circuit 2 are collaboratively formed as a first circuit. The second capacitor C2 and the second switching circuit 5 are collaboratively formed as a second circuit. The bidirectional resonant converter 1 receives or outputs a voltage Vin through the first port 11. The first port 11 includes a first positive terminal Vin+ and a first negative terminal Vin−. The bidirectional resonant converter 1 receives or outputs a voltage Vo through the second port 12. The second port 12 includes a second positive terminal Vo+ and a second negative terminal Vo−.

The first port 11 is coupled to a DC bus (not shown), and the voltage Vin inputted into the first port 11 is a DC bus voltage. The second port 12 is coupled to an energy storage unit (not shown), and the voltage Vo from the second port 12 is a voltage of an energy storage unit. When compared with the high-voltage DC bus, the energy storage unit is usually a low-voltage battery. The voltage Vin is greater than the voltage Vo. The voltages Vin and Vo are not fixed. That is, the voltage Vin and the voltage Vo may fluctuate within a certain range according to the actual situation. According to the energy flow direction between the first port 11 and the second port 12, the bidirectional resonant converter 1 is selectively operated in a charging mode or a discharging mode under the control of the controller 6. In the charging mode, the high voltage is converted into the low voltage. In the discharging mode, the low voltage is converted into the high voltage. In case that the energy flows from the first port 11 to the second port 12, the bidirectional resonant converter 1 is operated in the charging mode. That is, the voltage Vin of the first port 11 is converted into the voltage Vo to charge the energy storage unit. In case that the energy flows from the second port 12 to the first port 11, the bidirectional resonant converter 1 is operated in the discharging mode. That is, the voltage Vo of the second port 12 is converted into the voltage Vin.

The first switching circuit 2 includes a first bridge arm 21 and a second bridge arm 22. The first bridge arm 21 is electrically connected with the first capacitor C1 in parallel. The first bridge arm 21 includes a first switch Q1 and a second switch Q2, which are connected with each other in series. The connection point between the first switch Q1 and the second switch Q2 is a first node A. In addition, the driving signals for controlling the first switch Q1 and the second switch Q2 are complementary to each other. The second bridge arm 22 is connected with the first bridge arm 21 in parallel. The second bridge arm 22 includes a third switch Q3 and a fourth switch Q4, which are connected with each other in series. The connection point between the third switch Q3 and the fourth switch Q4 is a second node B. In addition, the driving signals for controlling the third switch Q3 and the fourth switch Q4 are complementary to each other. In the first switching circuit 2, a primary phase shift angle φₚ is formed between the first switch Q1 of the first bridge arm 21 and the fourth switch Q4 of the second bridge arm 22, and another primary phase shift angle φₚ is formed between the second switch Q2 of the first bridge arm 21 and the third switch Q3 of the second bridge arm 22.

The resonant circuit 3 includes a plurality of resonant branches. In this embodiment, the resonant circuit 3 includes a first resonant branch 31 and a second resonant branch 32. The first resonant branch 31 includes a first resonant capacitor Cr1 and a first resonant inductor Lr1. The second resonant branch 32 includes a second resonant capacitor Cr2 and a second resonant inductor Lr2. The capacitance of the first resonant capacitor Cr1 and the capacitance of the second resonant capacitor Cr2 may be equal or unequal. That is, the capacitance of the first resonant capacitor Cr1 and the capacitance of the second resonant capacitor Cr2 may be determined according to the practical requirements. The inductance of the first resonant inductor Lr1 and the inductance of the second resonant inductor Lr2 may be equal or unequal. That is, the inductance of the first resonant inductor Lr1 and the inductance of the second resonant inductor Lr2 may be determined according to the practical requirements.

The transformer 4 includes a plurality of primary windings. In addition, the resonant branches and the primary windings are collaboratively formed as a plurality of connection paths. In this embodiment, the first side of the transformer 4 includes a first primary winding 41 and a second primary winding 42, and the second side of the transformer 4 includes a secondary winding 43. The first primary winding 41 and the second primary winding 42 are coupled with each other. In other words, the transformer 4 is a center-tapped transformer.

In this embodiment, the resonant branches and the primary windings are collaboratively formed as a first connection path A1 and a second connection path A2. The first connection path A1 includes the first resonant branch 31 and the first primary winding 41. The first resonant branch 31 is electrically connected between the common-polarity terminal (i.e., the terminal marked as a black dot) of the first primary winding 41 and the first node A. The second connection path A2 includes the second resonant branch 32 and the second primary winding 42. The second resonant branch 32 is electrically connected between the common-polarity terminal of the second primary winding 42 and the first node A. In addition, each of first connection path A1 and the second connection path A2 is electrically connected between the first node A and the second node B.

The bidirectional resonant converter 1 further includes a selection unit. The selection unit includes a first switch or relay X1 and a second switch or relay X2. The first switch or relay X1 is arranged in the first connection path A1. For example, the first switch or relay X1 is arranged between the first node A and the first resonant branch 31. Of course, the first switch or relay X1 can be arranged in other locations of the first connection path A1, such as between the first resonant branch 31 and the first primary winding 41. In addition, the first switch or relay X1 is serially connected with the first connection path A1 to control the states of the first connection path A1. The second switch or relay X2 is arranged in the second connection path A2. For example, the second switch or relay X2 is arranged between the first node A and the second resonant branch 32. Of course, the second switch or relay X2 can be arranged in other locations of the second connection path A2, such as between the second resonant branch 32 and the second primary winding 42. In addition, the second switch or relay X2 is serially connected with the second connection path A2 to control the states of the second connection path A2.

Please refer to FIG. 1 again. The second switching circuit 5 includes a third bridge arm 51 and a fourth bridge arm 52. The third bridge arm 51 includes a fifth switch Q5 and a sixth switch Q6, which are connected with each other in series. The connection point between the fifth switch Q5 and the sixth switch Q6 is a third node C. The third node C is electrically connected with the common-polarity terminal of the secondary winding 43. In addition, the driving signals for controlling the fifth switch Q5 and the sixth switch Q6 are complementary to each other. The fourth bridge arm 52 is connected with the third bridge arm 51 in parallel. The fourth bridge arm 52 includes a seventh switch Q7 and an eighth switch Q8, which are connected with each other in series. The connection point between the seventh switch Q7 and the eighth switch Q8 is a fourth node D. The fourth node D is electrically connected with the opposite-polarity terminal of the secondary winding 43. In addition, the driving signals for controlling the seventh switch Q7 and the eighth switch Q8 are complementary to each other. The second capacitor C2 is connected with the third bridge arm 51 and the fourth bridge arm 52 in parallel. In the second switching circuit 5, a secondary phase shift angle φₛ is formed between the fifth switch Q5 of the third bridge arm 51 and the eighth switch Q8 of the fourth bridge arm 52, and another secondary phase shift angle φₛ is formed between the sixth switch Q6 of the third bridge arm 51 and the seventh switch Q7 of the fourth bridge arm 52. The difference between the secondary phase shift angle φₛ and the primary phase shift angle φₚ is defined as a primary-secondary phase shift angle φₚₛ.

The switches or relays X1 and X2 in the selection unit are controlled by the controller 6. By controlling the switches or relays X1 and X2 to change the states of the connection paths, the resonant branch and the primary winding in the operation are selected, and a resonant network is formed between the first node A and the second node B. Consequently, the energy is transferred from the first switching circuit 2 to the second switching circuit 5, or the energy is transferred from the second switching circuit 5 to the first switching circuit 2. Furthermore, the controller 6 determines the working mode of the bidirectional resonant converter 1. According to the determination result, the controller 6 controls the operation of the selection unit.

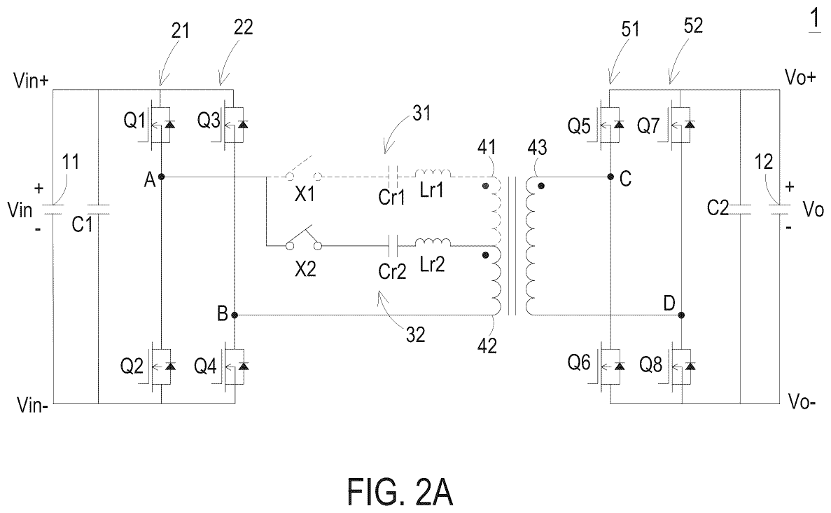

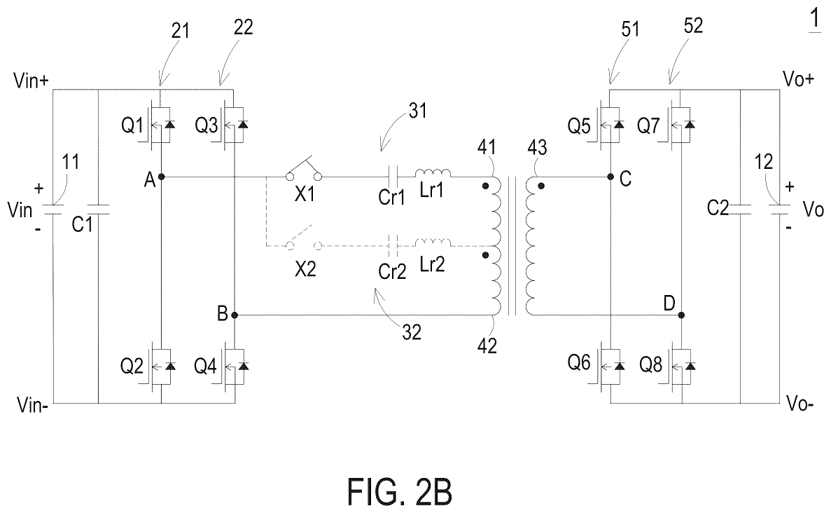

FIG. 2A is a schematic circuit diagram illustrating the operation of the bidirectional resonant converter of FIG. 1 and operated in a discharging mode. In case that the energy flows from the second port 12 to the first port 11, the controller 6 determines that the bidirectional resonant converter 1 is operated in the discharging mode for converting voltage. For example, the bidirectional resonant converter 1 converts the low voltage into the high voltage. The second switch or relay X2 is turned on and the first switch or relay X1 is turned off under the control of the controller 6. Consequently, the second connection path A2 is in the connected state, and the first connection path A1 is in the disconnected state. Under this circumstance, the second resonant branch 32 and the second primary winding 42 are selected to participate in energy conversion, and a first resonant cavity is formed between the first node A and the second node B. The current flows through the second resonant branch 32 and the second primary winding 42, and a voltage of the second primary winding 42 is induced by a voltage of the secondary winding 43. The turn ratio of the transformer 4 is equal to a first turn ratio n1, which is the ratio of the turn number of the second primary winding 42 to the turn number of the secondary winding 43. That is, the first turn ratio n1=N2/N3, wherein N2 is the turn number of the second primary winding 42, and N3 is the turn number of the secondary winding 43. The first resonant frequency fr1 of the first resonant cavity corresponds to the resonant frequency of the second resonant branch 32. In addition, the first resonant frequency fr1 can be obtained according to the following formula:

$$fr 1 = 1 / 2 π \sqrt{Lr 2 * Cr 2}$$

FIG. 2B is a schematic circuit diagram illustrating the operation of the bidirectional resonant converter of FIG. 1 and operated in a charging mode. In case that the energy flows from the first port 11 to the second port 12, the controller 6 determines that the bidirectional resonant converter 1 is operated in the charging mode for converting voltage. For example, the bidirectional resonant converter 1 converts the high voltage into the low voltage. The first switch or relay X1 is turned on and the second switch or relay X2 is turned off under the control of the controller 6. Consequently, the second connection path A1 is in the connected state, and the first connection path A2 is in the disconnected state. Under this circumstance, the first resonant branch 31, the first primary winding 41 and the second primary winding 42 are selected to participate in energy conversion, and a second resonant cavity is formed between the first node A and the second node B. The first primary winding 41 and the second primary winding 42 are serially connected with each other. The current flows through the first resonant branch 31, the first primary winding 41 and the second primary winding 42, and the voltage of the secondary winding 43 is induced by the voltages of the first primary winding 41 and the second primary winding 42. The turn ratio of the transformer 4 is equal to a second turn ratio n2, which is the ratio of the total turn number of the first primary winding 41 and the second primary winding 42 to the turn number of the secondary winding 43. That is, the second turn ratio n2=(N1+N2)/N3, wherein N1 is the turn number of the first primary winding 41, N2 is the turn number of the second primary winding 42, and N3 is the turn number of the secondary winding 43. The second resonant frequency fr2 of the second resonant cavity corresponds to the resonant frequency of the first resonant branch 31. In addition, the second resonant frequency fr2 can be obtained according to the following formula:

$$fr 2 = 1 / 2 π \sqrt{Lr 1 * Cr 1}$$

The switch or relay in the selection unit can change the state of the connection path flexibly. In addition, at least one resonant cavity is formed according to the circuitry topology and the circuit parameters, and the parameters of the resonant cavity are correspondingly changed. The corresponding resonant cavity is selected according to the working mode. Consequently, the bidirectional resonant converter can be operated in a wide voltage range, and the high-efficiency conversion of the electrical energy can be achieved.

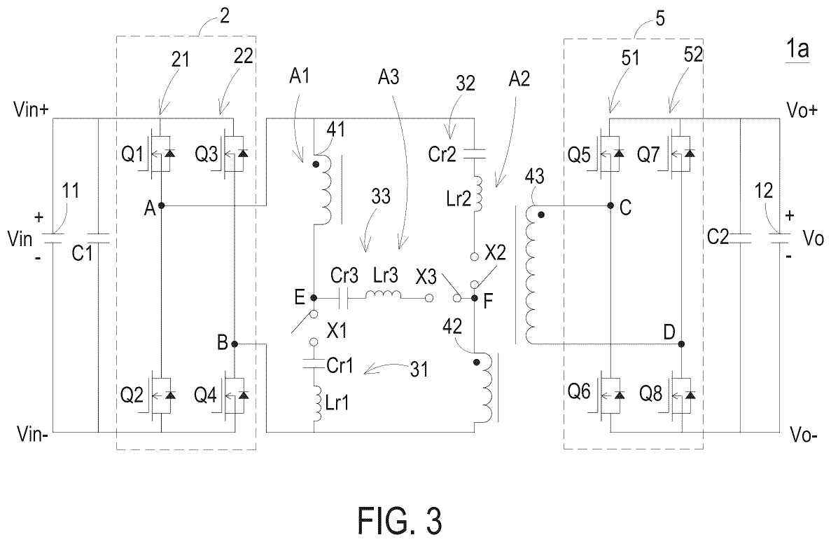

FIG. 3 is a schematic circuit diagram illustrating a circuitry topology of a bidirectional resonant converter according to a second embodiment of the present disclosure. In comparison with FIG. 1, the first primary winding 41 and the first resonant branch 31 in the bidirectional resonant converter 1a of this embodiment are electrically connected between the first node A and the second node B in series. That is, the first terminal of the first primary winding 41 is electrically connected with the first node A, the second terminal of the first primary winding 41 is electrically connected with the first terminal of the first resonant branch 31, and the second terminal of the first resonant branch 31 is electrically connected with the second node B. The connection point between the first primary winding 41 and the first resonant branch 31 is a fifth node E. Similarly, the second resonant branch 32 and the second primary winding 42 in the bidirectional resonant converter 1a of this embodiment are electrically connected between the first node A and the second node B in series. That is, the first terminal of the second resonant branch 32 is electrically connected with the first node A, the second terminal of the second resonant branch 32 is electrically connected with the first terminal of the second primary winding 42, and the second terminal of the second primary winding 42 is electrically connected with the second node B. The connection point between the second primary winding 42 and the second resonant branch 32 is a sixth node F.

In this embodiment, the resonant circuit 3 of the bidirectional resonant converter 1a further includes a third resonant branch 33. The third resonant branch 33 is electrically connected between the fifth node E and the sixth node F. The third resonant branch 33 includes a third resonant capacitor Cr3 and a third resonant inductor Lr3. The capacitance of the third resonant capacitor Cr3, the capacitance of the first resonant capacitor Cr1 and the capacitance of the second resonant capacitor Cr2 may be equal or unequal. That is, the capacitance of the third resonant capacitor Cr3, the capacitance of the first resonant capacitor Cr1 and the capacitance of the second resonant capacitor Cr2 may be determined according to the practical requirements. The inductance of the third resonant inductor Lr3, the inductance of the first resonant inductor Lr1 and the inductance of the second resonant inductor Lr2 may be equal or unequal. That is, the inductance of the third resonant inductor Lr3, the inductance of the first resonant inductor Lr1 and the inductance of the second resonant inductor Lr2 may be determined according to the practical requirements.

In this embodiment, the resonant branches and the primary windings are collaboratively formed as a first connection path A1, a second connection path A2 and a third connection path A3. The first connection path A1 includes the first resonant branch 31 and the first primary winding 41. The first resonant branch 31 is electrically connected between the opposite-polarity terminal of the first primary winding 41. In addition, the first connection path A1 is electrically connected between the first node A and the second node B. The second connection path A2 includes the second resonant branch 32 and the second primary winding 42. The second resonant branch 32 is electrically connected between the common-polarity terminal of the second primary winding 42. In addition, the second connection path A2 is electrically connected between the first node A and the second node B. The third connection path A3 includes the first primary winding 41, the third resonant branch 33 and the second primary winding 42. The third resonant branch 33 is electrically connected between the first primary winding 41 and the second primary winding 42. In addition, the third connection path A3 is electrically connected between the first node A and the second node B.

The selection unit includes a first switch or relay X1, a second switch or relay X2 and a third switch or relay X3. The first switch or relay X1 is arranged in the first connection path A1. For example, the first switch or relay X1 is arranged between the fifth node E and the first resonant branch 31. Of course, the first switch or relay X1 can be arranged in other locations of the first connection path A1. In addition, the first switch or relay X1 is serially connected with the first connection path A1 to control the on/off states of the first connection path A1. The second switch or relay X2 is arranged in the second connection path A2. For example, the second switch or relay X2 is arranged between the sixth node F and the second resonant branch 32. Of course, the second switch or relay X2 can be arranged in other locations of the second connection path A2. In addition, the second switch or relay X2 is serially connected with the second connection path A2 to control the on/off states of the second connection path A2. The third switch or relay X3 is arranged in the third connection path A3. For example, the third switch or relay X3 is arranged between the sixth node F and the third resonant branch 33. Of course, the third switch or relay X3 can be arranged in other locations of the third connection path A3. In addition, the third switch or relay X3 is serially connected with the third connection path A3 to control the on/off states of the third connection path A3.

The switches or relays X1, X2 and X3 in the selection unit are controlled by the controller 6. By controlling the switches or relays X1, X2 and X3 to change the states of the connection paths, the resonant branch and the primary winding in the operation are selected, and a resonant network is formed between the first node A and the second node B. Consequently, the energy is transferred from the first switching circuit 2 to the second switching circuit 5, or the energy is transferred from the second switching circuit 5 to the first switching circuit 2. Furthermore, the controller 6 determines the working mode of the bidirectional resonant converter 1a. According to the determination result, the controller 6 controls the operation of the selection unit.

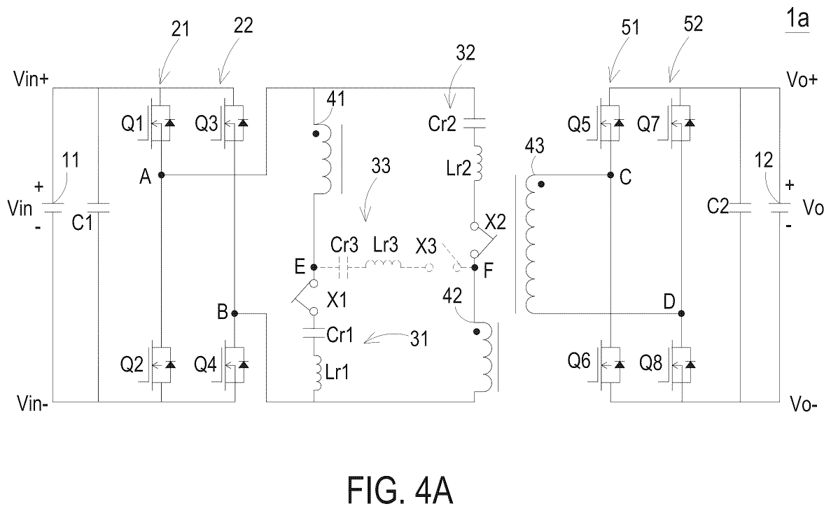

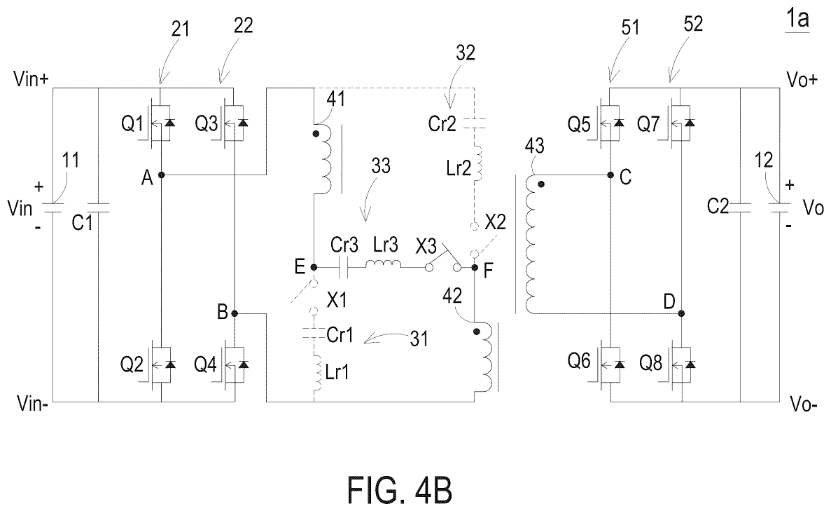

FIG. 4A is a schematic circuit diagram illustrating the operation of the bidirectional resonant converter of FIG. 3 and operated in a discharging mode. Please refer to FIG. 3 and FIG. 4A. In case that the energy flows from the second port 12 to the first port 11, the controller 6 determines that the bidirectional resonant converter 1a is operated in the discharging mode for converting voltage. For example, the bidirectional resonant converter 1a converts the low voltage into the high voltage. The first switch or relay X1 and the second switch or relay X2 are turned on and the third switch or relay X3 is turned off under the control of the controller 6. Consequently, the first connection path A1 and the second connection path A2 are in the connected state, and the third connection path A3 is in the disconnected state. Under this circumstance, the first resonant branch 31, the first primary winding 41, the second resonant branch 32 and the second primary winding 42 are selected to participate in energy conversion, and a first resonant cavity is formed between the first node A and the second node B. The current flows through the first resonant branch 31, the first primary winding 41, the second resonant branch 32 and the second primary winding 42, and the voltages of the first primary winding 41 and the second primary winding 42 are induced by the voltage of the secondary winding 43. The first resonant branch 31 and the first primary winding 41 are collaboratively formed as a first series connection unit. The second resonant branch 32 and the second primary winding 42 are collaboratively formed as a second series connection unit. The first series connection unit and the second series connection unit are connected with each other in parallel. The turn ratio of the transformer 4 is equal to a first turn ratio n1. The first turn ratio n1 is related to the ratio of the turn number of the first primary winding 41 to the turn number of the secondary winding 43 and the ratio of the turn number of the second primary winding 42 to the turn number of the secondary winding 43. The ratio of the turn number of the first primary winding 41 to the turn number of the secondary winding 43 is expressed as n11=N1/N3, and the ratio of the turn number of the second primary winding 42 to the turn number of the secondary winding 43 is expressed as n12=N2/N3, wherein N1 is the turn number of the first primary winding 41, N2 is the turn number of the second primary winding 42, and N3 is the turn number of the secondary winding 43. The first resonant cavity includes two units in parallel connection. The first resonant frequency fr1 of the first resonant cavity corresponds to the resonant frequency fr11 of the first resonant branch 31 and the resonant frequency fr12 of the second resonant branch 32. In addition, the resonant frequencies fr11 and fr12 can be obtained according to the following formulae:

$$fr 11 = 1 / 2 π \sqrt{Lr 1 * Cr 1}$$

$$fr 12 = 1 / 2 π \sqrt{Lr 2 * Cr 2}$$

For the convenience of calculation, the two resonant frequencies fr11 and fr12 are identical according to the practical requirements. The first resonant cavity includes two resonant circuits in parallel connection. This resonant cavity can be applied to the high-power occasions to reduce the current in the resonant cavity. Consequently, the voltage stress of the resonant capacitor will be reduced.

FIG. 4B is a schematic circuit diagram illustrating the operation of the bidirectional resonant converter of FIG. 3 and operated in a charging mode. In case that the energy flows from the first port 11 to the second port 12, the controller 6 determines that the bidirectional resonant converter 1a is operated in the charging mode for converting voltage. For example, the bidirectional resonant converter 1a converts the high voltage into the low voltage. The third switch or relay X3 is turned on and the first switch or relay X1 and the second switch or relay X2 are turned off under the control of the controller 6. Consequently, the third connection path A3 is in the connected state, and the first connection path A1 and the second connection path A2 are in the disconnected state. Under this circumstance, the third resonant branch 33, the first primary winding 41 and the second primary winding 42 are selected to participate in energy conversion, and a second resonant cavity is formed between the first node A and the second node B. The current flows through the first primary winding 41, the third resonant branch 33 and the second primary winding 42, and the first primary winding 41, the third resonant branch 33 and the second primary winding 42 are electrically connected with each other in series. The voltage of the secondary winding 43 is induced by the voltages of the first primary winding 41 and the second primary winding 42. The turn ratio of the transformer 4 is equal to a second turn ratio n2, which is the ratio of the total turn number of the first primary winding 41 and the second primary winding 42 to the turn number of the secondary winding 43. That is, the second turn ratio n2=(N1+N2)/N3, wherein N1 is the turn number of the first primary winding 41, N2 is the turn number of the second primary winding 42, and N3 is the turn number of the secondary winding 43. The second resonant frequency fr2 of the second resonant cavity corresponds to the resonant frequency of the third resonant branch 33. In addition, the second resonant frequency fr2 can be obtained according to the following formula:

$$fr 2 = \frac{1}{2 π \sqrt{Lr 3 * Cr 3}}$$

The second resonant cavity is defined by two circuits in series connection. Consequently, the resonant frequency of the resonant cavity is increased, and the switching frequency is reduced. In this way, the soft switching function of the resonant circuit under the light load condition is easily achieved.

In the above embodiment, the first connection path A1 and the second connection path A2 are selected in the discharging mode, and the third connection path A3 is selected in the charging mode. It is noted that numerous modifications may be made according to the practical requirements and the resonant parameters. In another embodiment, at least one of the first connection path A1, the second connection path A2 and the third connection path A3 is selected in the discharging mode for converting the low voltage into the high voltage. Similarly, in a variant example, at least one of the first connection path A1, the second connection path A2 and the third connection path A3 is selected in the charging mode for converting the high voltage into the low voltage.

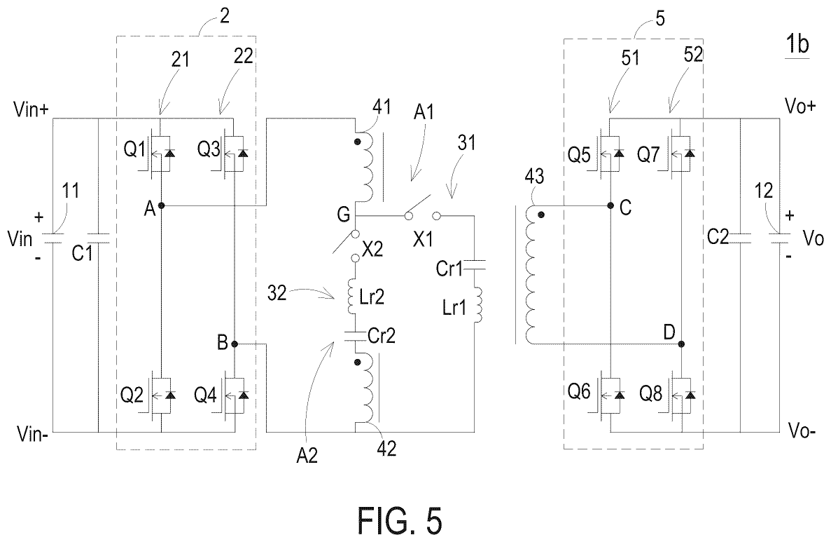

FIG. 5 is a schematic circuit diagram illustrating a circuitry topology of a bidirectional resonant converter according to a third embodiment of the present disclosure. In comparison with FIG. 1, the first primary winding 41, the second resonant branch 32 and the second primary winding 42 in the bidirectional resonant converter 1b of this embodiment are electrically connected between the first node A and the second node B in series. The connection point between the first primary winding 41 and the second resonant branch 32 is a seventh node G. The first resonant branch 31 in the bidirectional resonant converter 1b of this embodiment is electrically connected between the seventh node G and the second node B.

In this embodiment, the resonant branches and the primary windings are collaboratively formed as a first connection path A1 and a second connection path A2. The first connection path A1 includes the first resonant branch 31 and the first primary winding 41. The first resonant branch 31 is electrically connected with the opposite-polarity terminal of the first primary winding 41. The first connection path A1 is electrically connected between the first node A and the second node B. The second connection path A2 includes the second resonant branch 32, the first primary winding 41 and the second primary winding 42. The second resonant branch 32 is electrically connected between the common-polarity terminal of the second primary winding 42 and the opposite-polarity terminal of the first primary winding 41. The second connection path A2 is electrically connected between the first node A and the second node B.

The selection unit includes a first switch or relay X1 and a second switch or relay X2. The first switch or relay X1 is arranged in the first connection path A1. For example, the first switch or relay X1 is arranged between the seventh node G and the first resonant branch 31. In addition, the first switch or relay X1 is serially connected with the first connection path A1 to control the on/off states of the first connection path A1. The second switch or relay X2 is arranged in the second connection path A2. For example, the second switch or relay X2 is arranged between the seventh node G and the second resonant branch 32. In addition, the second switch or relay X2 is serially connected with the second connection path A2 to control the on/off states of the second connection path A2.

The switches or relays X1 and X2 in the selection unit are controlled by the controller 6. By controlling the switches or relays X1 and X2 to change the states of the connection paths, the resonant branch and the primary winding in the operation are selected, and a resonant network is formed between the first node A and the second node B. Consequently, the energy is transferred from the first switching circuit 2 to the second switching circuit 5, or the energy is transferred from the second switching circuit 5 to the first switching circuit 2. Furthermore, the controller 6 determines the working mode of the bidirectional resonant converter 1b. According to the determination result, the controller 6 controls the operation of the selection unit.

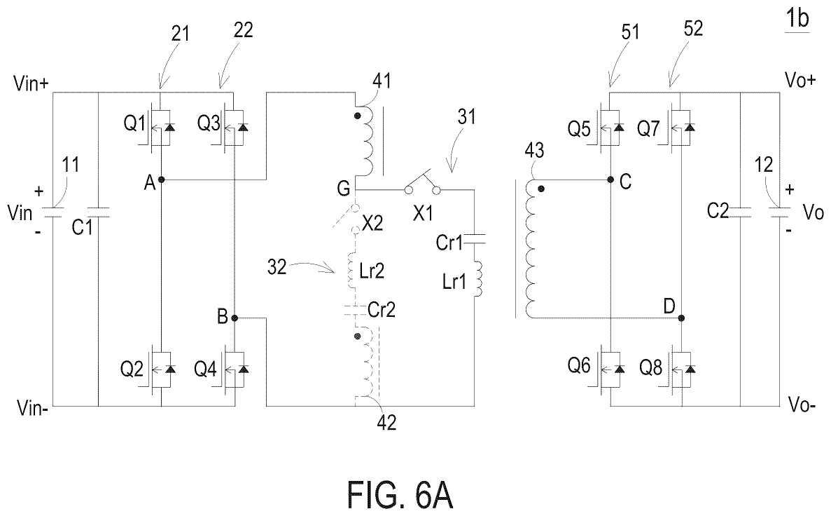

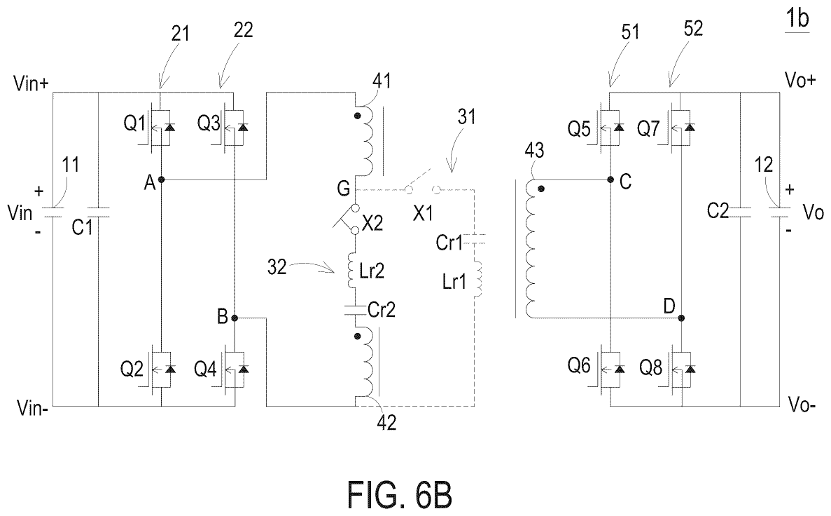

FIG. 6A is a schematic circuit diagram illustrating the operation of the bidirectional resonant converter of FIG. 5 and operated in a discharging mode. Please refer to FIG. 5 and FIG. 6A. In case that the energy flows from the second port 12 to the first port 11, the controller 6 determines that the bidirectional resonant converter 1b is operated in the discharging mode for converting voltage. For example, the bidirectional resonant converter 1b converts the low voltage into the high voltage. The first switch or relay X1 is turned on and the second switch or relay X2 is turned off under the control of the controller 6. Consequently, the first connection path A1 is in the connected state, and the second connection path A2 is in the disconnected state. Under this circumstance, the first resonant branch 31 and the first primary winding 41 are selected to participate in energy conversion, and a first resonant cavity is formed between the first node A and the second node B. The current flows through the first resonant branch 31 and the first primary winding 41, and the voltage of the first primary winding 41 is induced by the voltage of the secondary winding 43. The turn ratio of the transformer 4 is equal to a first turn ratio n1, which is the ratio of the turn number of the first primary winding 41 to the turn number of the secondary winding 43.

That is, the first turn ratio n1=N1/N3, wherein N1 is the turn number of the first primary winding 41, and N3 is the turn number of the secondary winding 43. The first resonant frequency fr1 of the first resonant cavity corresponds to the resonant frequency of the first resonant branch 31. In addition, the first resonant frequency fr1 can be obtained according to the following formula:

$$fr 1 = 1 / 2 π \sqrt{Lr 1 * Cr 1}$$

FIG. 6B is a schematic circuit diagram illustrating the operation of the bidirectional resonant converter of FIG. 5 and operated in a charging mode. Prefer refer to FIG. 5 and FIG. 6B. In case that the energy flows from the first port 11 to the second port 12, the controller 6 determines that the bidirectional resonant converter 1b is operated in the charging mode for converting voltage. For example, the bidirectional resonant converter 1b converts the high voltage into the low voltage. The second switch or relay X2 is turned on and the first switch or relay X1 is turned off under the control of the controller 6. Consequently, the second connection path A2 is in the connected state, and the first connection path A1 is in the disconnected state. Under this circumstance, the first primary winding 41, the second resonant branch 32 and the second primary winding 42 are selected to participate in energy conversion, and a second resonant cavity is formed between the first node A and the second node B. The current flows through the first primary winding 41, the second resonant branch 32 and the second primary winding 42. The first primary winding 41, the second resonant branch 32 and the second primary winding 42 are serially connected with each other. The voltage of the secondary winding 43 is induced by the voltages of the first primary winding 41 and the second primary winding 42. The turn ratio of the transformer 4 is equal to a second turn ratio n2, which is the ratio of the total turn number of the first primary winding 41 and the second primary winding 42 to the turn number of the secondary winding 43. That is, the second turn ratio n2=(N1+N2)/N3, wherein N1 is the turn number of the first primary winding 41, N2 is the turn number of the second primary winding 42, and N3 is the turn number of the secondary winding 43. The second resonant frequency fr2 of the second resonant cavity corresponds to the resonant frequency of the second resonant branch 32. In addition, the second resonant frequency fr2 can be obtained according to the following formula:

$$fr 2 = 1 / 2 π \sqrt{Lr 2 \times Cr 2}$$

According to the working mode of the bidirectional resonant converter, the resonant cavity and the primary winding to participate in the operation are selected by the controller 6. For example, in case that the bidirectional resonant converter is operated in the discharging mode for converting the low voltage into the high voltage, the first resonant cavity is selected to participate in energy conversion, and the ratio of the turn number of the corresponding primary winding to the turn number of the secondary winding is equal to the first turn ratio n1 of the transformer 4. Whereas, in case that the bidirectional resonant converter is operated in the charging mode for converting the high voltage into the low voltage, the second resonant cavity is selected to participate in energy conversion, the ratio of the turn number of the corresponding primary winding to the turn number of the secondary winding is equal to the second turn ratio n2 of the transformer 4. After the resonant cavity and the primary winding to participate in energy conversion are determined, the controller 6 calculates the corresponding resonant frequency and the voltage gain. According to the voltage gain and the working mode of the resonant converter, the primary phase shift angle φₚ, the secondary phase shift angle φₛ and the primary-secondary phase shift angle φₚₛ are calculated.

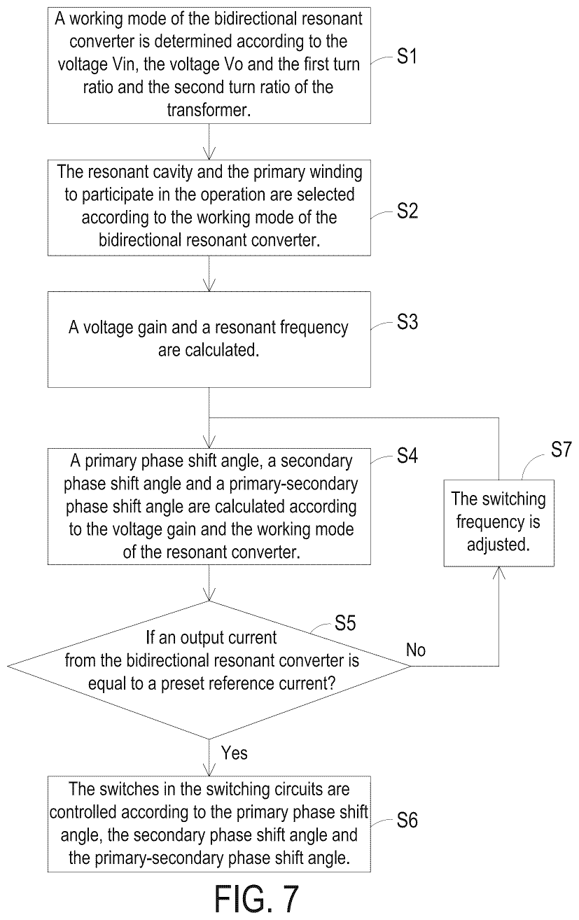

FIG. 7 is a flowchart illustrating a control method for the bidirectional resonant converter shown in FIG. 1. In an embodiment, the controller 6 is a DSP control chip. The control method is implemented by the controller 6. The control method includes the following steps S1˜S7.

In the step S1, a working mode of the bidirectional resonant converter is determined according to the voltage Vin, the voltage Vo, the first turn ratio n1 of the transformer 4 and the second turn ratio n2 of the transformer 4.

In an embodiment, the step S1 includes two sub-steps S11 and S12. In the sub-step S11, the voltage Vin from the first port 11 and the voltage Vo from the second port 12 are received. In the sub-step S12, the terms |n1×Vo/Vin−1| and |n2×Vo/Vin−1| are compared with each other. If |n1×Vo/Vin−1|<|n2×Vo/Vin−1|, the controller 6 determines that the bidirectional resonant converter is operated in the high-to-low voltage conversion mode (i.e., the charging mode). If |n1×Vo/Vin−1|>|n2×Vo/Vin −1|, the controller 6 determines that the bidirectional resonant converter is operated in the low-to-high voltage conversion mode (i.e., the discharging mode).

In the step S2, the resonant cavity and the primary winding to participate in the operation are selected according to the working mode of the bidirectional resonant converter.

In the step S3, a voltage gain M and a resonant frequency are calculated. If the bidirectional resonant converter is operated in the low-to-high voltage conversion mode, the transformation ratio of the transformer 4 is equal to the first turn ratio n1. The first resonant cavity is selected to participate in energy conversion. The voltage gain M is calculated according to the following formula (2-1). The resonant frequency fr is the first resonant frequency fr1. If the bidirectional resonant converter is operated in the high-to-low voltage conversion mode, the transformation ratio of the transformer 4 is equal to the second turn ratio n2. The second resonant cavity is selected to participate in energy conversion. The voltage gain M is calculated according to the following formula (2-2). The resonant frequency fr is the second resonant frequency fr2.

$$M = \{ \begin{matrix}\frac{n 1 * {V}_{o}}{{V}_{in}} if \vert \frac{n 1 * {V}_{o}}{{V}_{in}} - 1 \vert \leq \vert \frac{n 2 * {V}_{o}}{{V}_{in}} - 1 \vert & & & & & ( 2 - 1 ) \\ \frac{n 2 * {V}_{o}}{{V}_{in}} if \vert \frac{n 1 * {V}_{o}}{{V}_{in}} - 1 \vert > \vert \frac{n 2 * {V}_{o}}{{V}_{in}} - 1 \vert & & & & & ( 2 - 2 )\end{matrix}$$

In the step S4, a primary phase shift angle φₚ, a secondary phase shift angle φₛ and a primary-secondary phase shift angle φₚₛ are calculated according to the voltage gain M and the working mode of the resonant converter. In an embodiment, the primary phase shift angle φₚ, the secondary phase shift angle φₛ and the primary-secondary phase shift angle φₚₛ are according to the following table 1 and the formulae (3), (4) and (5).

TABLE 1

| Energy flow direction | M | φₚ | φₛ | φₚₛ |
|---|---|---|---|---|
| Vin to Vo (high-to-low | ≤1 | φ₁ | 0 | φ₂ + φ₃ + φ₁ |
| voltage conversion mode) | >1 | 0 | φ₁ | φ₃ + φ₂ |
| Vo to Vin (low-to-high | ≤1 | 0 | φ₁ | φ₃ + φ₂ |
| voltage conversion mode) | >1 | φ₁ | 0 | φ₂ + φ₃ + φ₁ |

$${φ}_{2} = 2 π {Tf}_{s} \qquad ( 3 )$$

$${φ}_{3} = 2 π {kTf}_{s} \qquad ( 4 )$$

$${φ}_{1} = \{ \begin{matrix}max ( arc cos ( 2 M - cos ( {φ}_{2} + {φ}_{3} ) ) - ( {φ}_{3} + {φ}_{2} ) , 0 ) if M \leq 1 \\ max ( arc cos ( \frac{2 cos ( {φ}_{2} )}{M} - cos ( {φ}_{3} ) ) - {φ}_{3} , 0 ) if M > 1\end{matrix} \qquad ( 5 )$$

In the above formulae, T is a fixed time period, fs is a switching frequency, and k is a natural number greater than 0.

The step S5 is performed to determine whether an output current from the bidirectional resonant converter is equal to a preset reference current. In this step, the output current Iₒ is calculated according to the formula (6). In addition, the calculated output current Iₒ is compared with the normalized reference current Iref.

$${I}_{o} = \frac{8 {n}^{2} {V}_{o}^{2}}{{π}^{2} {P}_{o} \sqrt{\frac{Lr}{Cr}} ( \frac{fs}{fr} - \frac{fr}{fs} )} cos ( \frac{{φ}_{p}}{2} ) cos ( \frac{{φ}_{s}}{2} ) sin ( {φ}_{ps} ) \qquad ( 6 )$$

In the above formula, Po is the output power of the bidirectional resonant converter, and fs is the switching frequency.

If the determining condition of the step S5 is satisfied, the step S6 is performed. In the step S6, the switches in the switching circuits are controlled according to the primary phase shift angle φₚ, the secondary phase shift angle φₛ and the primary-secondary phase shift angle φₚₛ.

If the determining condition of the step S5 is not satisfied, a step S7 is performed. In the step S7, the switching frequency fs is adjusted. Then, the step S4 is repeatedly done.

From the above descriptions, the present disclosure provides the bidirectional resonant converter. Each resonant branch is electrically connected with at least one primary winding of the transformer. The resonant branches and the corresponding primary windings are collaboratively formed as a plurality of connection paths. The selection unit is electrically connected with a plurality of connection paths. Through the selection unit, at least one connection path of the plurality of connection paths is selected. Consequently, a resonant cavity between the first switching circuit and the transformer is formed. According to the technology of the present disclosure, the parameters of the resonant cavity are correspondingly changed. The corresponding resonant cavity is selected according to the working mode. The bidirectional resonant converter can be operated in a wide voltage range, and the high-efficiency conversion of the electrical energy can be achieved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bidirectional resonant converter, comprising:
a first port;
a second port;
a first circuit electrically connected with the first port;
a resonant circuit electrically connected with the first circuit, and comprising a plurality of resonant branches;
a transformer electrically connected with the resonant circuit and comprising a plurality of primary windings and a secondary winding;
a second circuit electrically connected between the transformer and the second port; and
a selection unit;
wherein each resonant branch is electrically connected with at least one primary winding, and the plurality of resonant branches and the corresponding primary windings are collaboratively formed as a plurality of connection paths;
wherein the selection unit is electrically connected with the plurality of connection paths, and configured to select at least one connection path from the plurality of connection paths.

2. The bidirectional resonant converter according to claim 1, wherein the selection unit includes a plurality of switches or relays, and each switch or relay is electrically connected with the corresponding connection path.

3. The bidirectional resonant converter according to claim 2, further comprising a controller configured to determine a working mode of the bidirectional resonant converter, and control the plurality of switches or relays according to the working mode of the bidirectional resonant converter.

4. The bidirectional resonant converter according to claim 3, wherein when the controller determines that the bidirectional resonant converter is operated in a first working mode, the at least one connection path is selected to form a first resonant cavity between the first circuit and the transformer; and
when the controller determines that the bidirectional resonant converter is operated in a second working mode, the at least one connection path is selected to form a second resonant cavity between the first circuit and the transformer.

5. The bidirectional resonant converter according to claim 4, wherein a turn ratio of the transformer is determined according to a turn number of at least one primary winding in the at least one connection path selected and a turn number of the secondary winding, and a resonant frequency of the first resonant cavity or the second resonant cavity is determined according to at least one resonant branch in the at least one connection path selected.

6. The bidirectional resonant converter according to claim 4, wherein the first working mode is a discharging mode or a low-to-high voltage conversion mode; and
the second working mode is a charging mode or a high-to-low voltage conversion mode.

7. The bidirectional resonant converter according to claim 4, wherein the resonant circuit comprises a first resonant branch and a second resonant branch;
the transformer comprises a first primary winding electrically connected with the first resonant branch to form a first connection path, and a second primary winding electrically connected with the second resonant branch to form a second connection path; and
the select unit comprises a first switch serially connected in the first connection path, and a second switch serially connected in the second connection path.

8. The bidirectional resonant converter according to claim 7, wherein when the bidirectional resonant converter is operated in the first working mode, the second switch is turned on and the first switch is turned off so that the second connection path is connected to form the first resonant cavity, wherein the resonant frequency of the first resonant cavity is a resonant frequency of the second resonant branch, and the turn ratio is a ratio of a turn number of the second primary winding to a turn number of the secondary winding.

9. The bidirectional resonant converter according to claim 7, wherein when the bidirectional resonant converter is operated in the second working mode, the first switch is turned on and the second switch is turned off so that the first connection path is connected to form the second resonant cavity, wherein the resonant frequency of the second resonant cavity is a resonant frequency of the first resonant branch, and the turn ratio is a ratio of a total turn number of the first primary winding and the second primary winding to a turn number of the secondary winding.

10. The bidirectional resonant converter according to claim 7, wherein the transformer is a center-tapped transformer.

11. The bidirectional resonant converter according to claim 4, wherein the resonant circuit comprises a first resonant branch, a second resonant branch and a third resonant branch;
the transformer comprises a first primary winding electrically connected with the first resonant branch to form a first connection path, and a second primary winding electrically connected with the second resonant branch to form a second connection path;
the third resonant branch electrically connected with the first primary winding and the second primary winding to form a third connection path; and
the select unit comprises a first switch serially connected in the first connection path, a second switch serially connected in the second connection path, and a third switch serially connected in the third connection path.

12. The bidirectional resonant converter according to claim 11, wherein when the bidirectional resonant converter is operated in the first working mode, the first switch and the second switch are turned on and the third switch is turned off so that the first connection path and the second connection path are connected to form the first resonant cavity.

13. The bidirectional resonant converter according to claim 12, wherein the first connection path and the second connection path are electrically connected in parallel and collaboratively form the first resonant cavity, wherein the resonant frequency of the first resonant cavity is determined by a resonant frequency of the first resonant branch and a resonant frequency of the second resonant branch, and the turn ratio is determined by a ratio of a turn number of the first primary winding to a turn number of the secondary winding and a ratio of a turn number of the second primary winding to the turn number of the secondary winding.

14. The bidirectional resonant converter according to claim 11, wherein when the bidirectional resonant converter is operated in the second working mode, the third switch is turned on and the first switch and the second switch are turned off so that the third connection path is connected to form the second resonant cavity, wherein the resonant frequency of the second resonant cavity is a resonant frequency of the third resonant branch, and the turn ratio is a ratio of a total turn number of the first primary winding and the second primary winding to a turn number of the secondary winding.

15. The bidirectional resonant converter according to claim 4, wherein the resonant circuit comprises a first resonant branch and a second resonant branch;
the transformer comprises a first primary winding electrically connected with the first resonant branch to form a first connection path, and a second primary winding electrically connected with the first primary winding and the second resonant branch to form a second connection path; and
the select unit comprises a first switch serially connected in the first connection path, and a second switch serially connected in the second connection path.

16. The bidirectional resonant converter according to claim 15, wherein when the bidirectional resonant converter is operated in the first working mode, the first switch is turned on and the second switch is turned off so that the first connection path is connected to form the first resonant cavity, wherein the resonant frequency of the first resonant cavity is a resonant frequency of the first resonant branch, and the turn ratio is a ratio of a turn number of the first primary winding to a turn number of the secondary winding.

17. The bidirectional resonant converter according to claim 15, wherein when the bidirectional resonant converter is operated in the second working mode, the second switch is turned on and the first switch is turned off so that the second connection path is connected to form the second resonant cavity, wherein the resonant frequency of the second resonant cavity is a resonant frequency of the second resonant branch, and the turn ratio is a ratio of a total turn number of the first primary winding and the second primary winding to a turn number of the secondary winding.
